(19) United States
(12) Patent Application Publication
(10) Pub. No.: US 2003/0069116 A1
(43) Pub. Date: Apr. 10, 2003

(54) Method and apparatus for producing box-edges on objects

(76) Inventors: Larry E. Wolfe JR., Chillicothe, OH (US); Robert C. Johnson, Frankfort, OH (US)

Correspondence Address: Robert C. Johnson and Larry E. Wolfe, Jr., Johnson-Wolfe & Associates, LLC, 9947 Egypt Pike, Frankfort, OH, 45628, US

(21) Appl. No.: 09/817,996

(22) Filed: Mar. 27, 2001

Related U.S. Application Data
(60) Provisional application No. 60/196,638, filed on Apr. 12, 2000.

(51) Int. Cl. B31B 3/00

(52) U.S. Cl. 493/52

(57) ABSTRACT

An apparatus is taught for producing box-edges on objects. The apparatus comprises a coupling system, a guiding system operatively configured to interact with an object to form a box-edge on a portion of the object, and an adjusting system operatively configured to adjust predetermined portions of the guiding system such that the box-edge conforms to predetermined parameters. Also, a method is taught for producing box-edges on objects. The method comprises the steps of feeding an object into a first portion of a system, moving the object from the first portion of the system to a second portion of the system, interacting a portion of the object with an apparatus in the second portion of the system to form a box-edge section on the object, interacting sections of the object with a third portion of the system to secure the box-edge section, and moving the object to a fourth portion of the system after the box-edge section is secured.

### BACKGROUND OF THE INVENTION

The present invention is related to an apparatus for modifying a folder-gluer machine to automatically make complex folders, and more particularly to an apparatus configured to modify a folder-gluer machine to automatically produce box-edge capacity-type folders.

In today's business market competition for customers is at an all time high. These customers have an ever-increasing demand for information about companies and their services. Many companies distribute this information in kits assembled from folders filled with brochures and copied materials. To be competitive, these kits have become increasingly more attractive and filled with a large amount of information. This has lead to problems since most folders are of a flat pocket variety and are not designed to hold more than a few printed sheets of information without damaging their pockets. Hence, this has caused a demand in the market for different kinds of folders.

To meet this market demand, companies that produce folders have devised new folder configurations to hold a large volume of materials. A prominent design in the art utilizes a box-edge configuration with one or both pockets having a ⅛″ or larger edge, which allows the pockets to hold significantly more materials than conventional flat pocket type folders. One major drawback to the box-edge folder is that they are inefficient and relatively expensive to produce because manual labor has to be employed to fold and glue the “box-edge” shape of the folders. This has resulted in slow turn-around for high volume orders of box-edge folders, and possibly lost business if the printer/converter is unable to meet the demands of a customer. One solution is to increase the manpower associated with the jobs, e.g., to hire more workers for larger orders or have the workers work longer hours. Unfortunately, this solution is not cost effective and, depending upon the quality of the labor pool, may lead to inconsistent quality and results.

What is needed is an apparatus that is easily integrated into a wide variety of existing folder-gluer machines that modifies the operation of the machine to automatically produce a high volume of quality box-edge folders in a cost-effective manner.

### SUMMARY OF THE INVENTION

This present invention overcomes all these above-mentioned shortcomings of the prior art devices.

According to an embodiment of the present invention, an apparatus is taught for producing box-edges on objects. The apparatus comprises a coupling system, a guiding system operatively configured to interact with an object to form a box-edge on a portion of the object, and an adjusting system operatively configured to adjust predetermined portions of the guiding system such that the box-edge conforms to predetermined parameters.

According to another embodiment of the present invention, a system is taught for producing box-edges on objects. The system comprises a folder-gluer apparatus and an apparatus. The apparatus comprises a coupling system, a guiding system operatively configured to interact with an object to form a box-edge on a portion of the object, and an adjusting system operatively configured to adjust predetermined portions of the guiding system such that the box-edge conforms to predetermined parameters.

According to another embodiment of the present invention, a method is taught for producing box-edges on objects. The method comprises the steps of feeding an object into a first portion of a system, moving the object from the first portion of the system to a second portion of the system, interacting a portion of the object with an apparatus in the second portion of the system to form a box-edge section on the object, interacting sections of the object with a third portion of the system to secure the box-edge section, and moving the object to a fourth portion of the system after the box-edge section is secured.

A main advantage of the present invention is that production of box-edge folders can be increased from approximately 100 units an hour (manually) to approximately 7000 units an hour.

Another advantage of the present invention is that the box-edge producing apparatus allows for quicker set-up when modifying a folder-gluer machine to produce box-edge folders as compared to dedicated folding devices. The invention accommodates a wide range of folder capacities without requiring specialized dies or tooling.

A still further advantage of the present invention is that the box-edge folders produced are of a higher quality and more consistent quality compared to folders produced by hand.

A still further advantage of the present invention is that this apparatus can be integrated directly into a wide variety of folder/gluer machines or coupled to any present folder/gluer machine as a stand-alone component.

Thus, the present invention is easier, more cost-effective, and more convenient to use than conventional devices or manual processes.

A still further advantage of the present invention is that it can be fine-tuned while the box-edge folders are being produced, i.e., “on the fly”, without shutting down the machine. Thus, not only are scrap and waste reduced, which further decreases the costs of producing the folders, but the time needed to finish the run is decreased since there is no downtime during adjustments. In one scenario, scrap was reduced 50-75%.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a top view of a box-edge folder blank that has been die cut and scored but yet passed through a folder/gluer machine according to a first embodiment of the present invention;

FIG. 2A is an elevational view along line A-A of the folder in FIG. 1 after the folder has passed through the machine;

FIG. 2B is an elevational view along line B-B of the folder in FIG. 1 after the folder has passed through the machine;

FIG. 2C is an elevational view along line C-C of the folder in FIG. 1 after the folder has passed through the machine;

FIG. 2D is an elevational view along line D-D of the folder in FIG. 1 after the folder has passed through the machine;

FIG. 2E is a plan view of the folder in FIG. 1 after the folder has passed through the machine;

FIG. 3 is a plan view of a section of a system comprising a folder/gluer apparatus with an attached apparatus for producing a box-edge on an object according to a first embodiment of the present invention;

FIG. 4 is a detailed illustration of a coupling between a section of the apparatus for producing a box-edge on an object and a section of the folder/gluer apparatus according to the first embodiment of the present invention;

FIG. 5A-B are elevational views of the apparatus, holding devices, a gluing device, and a folding device for producing a box-edge on an object according to the first embodiment of the present invention;

FIGS. 6A-B are elevational views of plows that make up a section of the apparatus for producing a box-edge on an object shown in FIGS. 5A-B;

FIG. 7 is an end view from the [input] or [output] end of the apparatus for producing a box-edge on an object shown in FIGS. 5A-B;

FIGS. 8A is an exploded view of a fine adjustment device as shown in FIGS. 5A-B; and

FIG. 8B is an assembled view of the fine adjustment device as shown in FIG. 8A.

### DESCRIPTION OF THE PREFERRED EMBODIMENT(S)

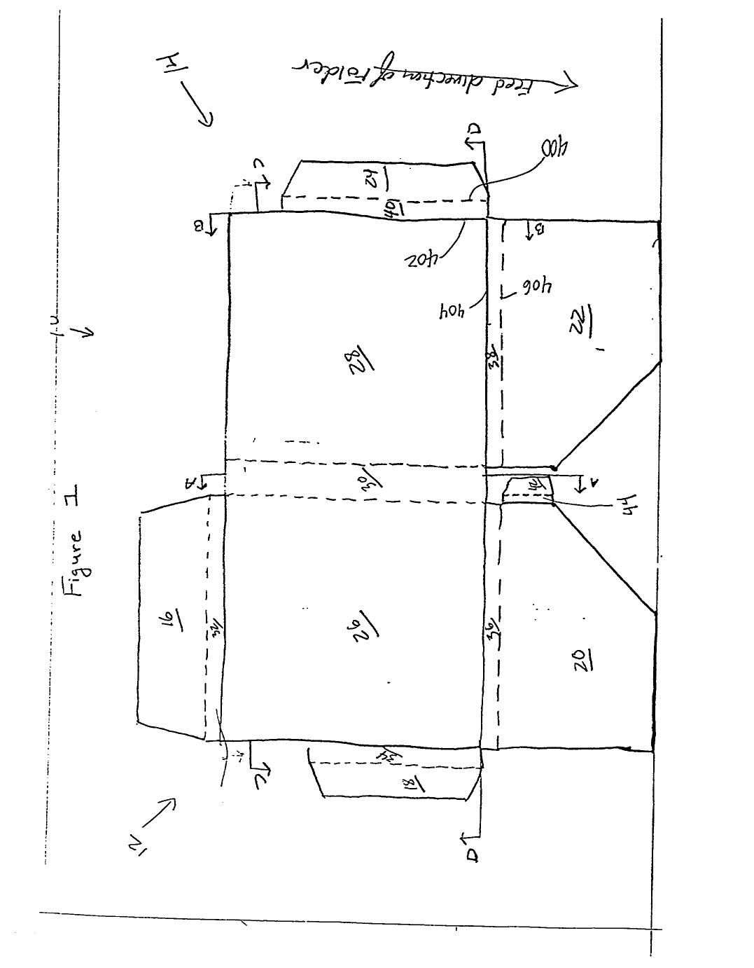

With reference to FIG. 1, an object 10, preferably a die cut and pre-scored folder blank, according to a first embodiment of the present invention is shown. The folder 10 is comprised of a left 12 and right 14 side. There are three extensions 16, 18, and 20 from the left side 12 and two extensions 22 and 24 from the right side 14. These extensions 16, 18, 20, 22, and 24 extend from a left side main body 26 and a right side main body 28, which are separated by a middle section 30. Between the extensions 16, 18, 20, 22, and 24 and the left and right side main bodies 26 and 28 there are provided box-edge sections 32, 34, 36, 38, and 40. Also, the extension 20 has a lateral extension 42 separated from extension 20 by a box-edge section 44. All dashed and straight lines on either side of the box-edge sections 32-40 are pre-scored areas of the folder 10 that more easily and accurately allow the folds to occur, as known in the art.

All similar elements carry the same element numbers throughout the figures. Also, it is to be appreciated this is only a preferred embodiment of an object or folder with box-edges, where many alternative arrangements are contemplated by the present invention. For instance, in alternative arrangements there may be only one box-edge side of the folder or additional fold elements such as 16 and/or 42 may not exist. A box-edge is where a folder has one or more pockets that have defined pocket bottom/edge of ¼ or higher heights instead of a conventional folder with a non-existent pocket bottom, i.e., a flat pocket.

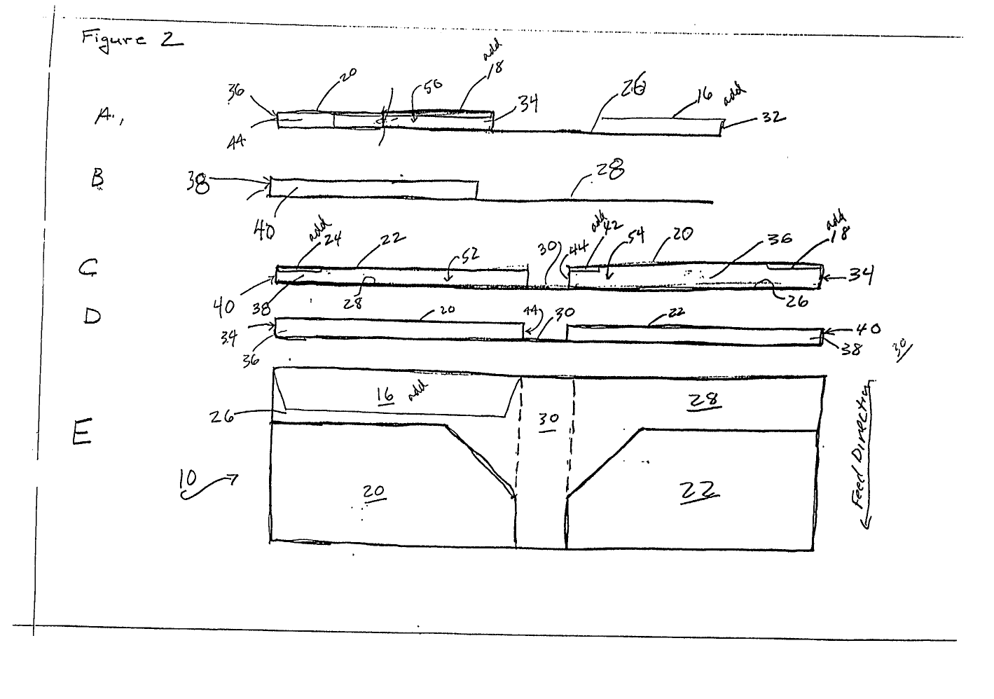

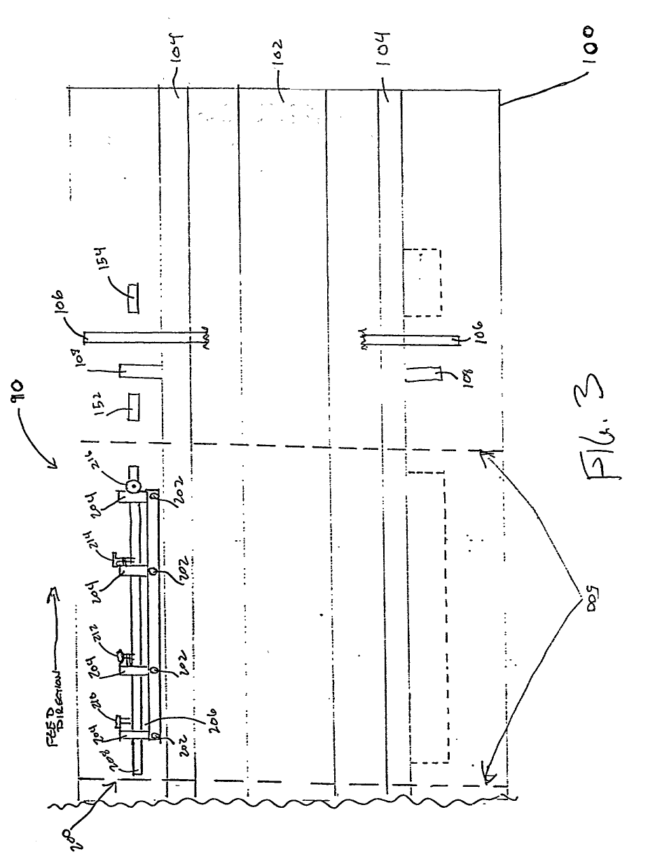

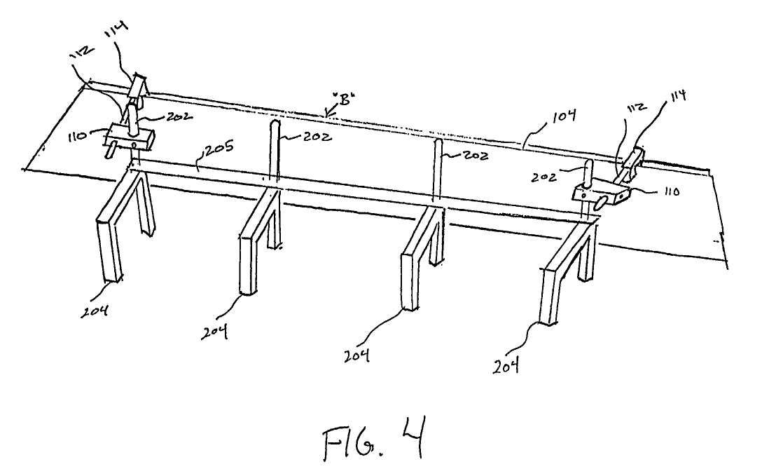

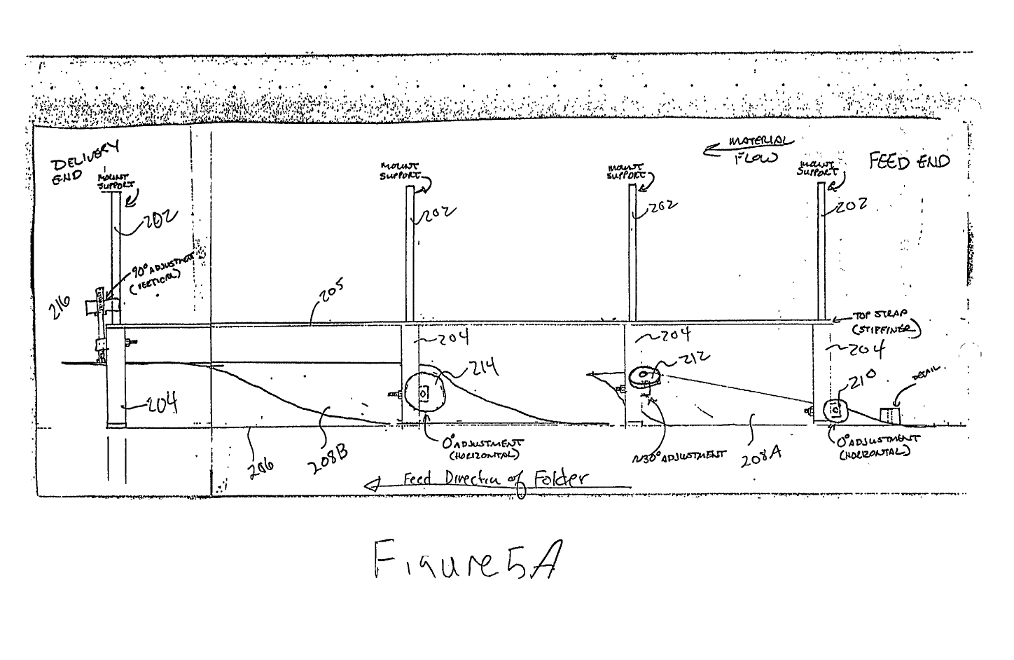

Turning additionally now to FIGS. 2A-E, a post-production view of folder 10 is shown. FIG. 2A shows a side or elevational view looking into section A-A in FIG. 1. The extensions 18 and 20 have been permanently secured or coupled through use of securing means, such as adhesive materials as known in the art. Unless otherwise discussed, all other extensions are coupled through similar means. Also, extensions 18 and 42 have been permanently coupled to the extension 20. Hence, box-edges 34, 36, and 44 have been formed to a predetermined height, e.g., ¼-¾ inch, as set up by the machine operator. Unless otherwise discussed, all box-edges have similar parameters. Shown in FIG. 2A are the outside surface of box-edge 44, the front edge of box-edge 36, and the inside surface of box-edge 34, where box-edge 34 is located inside of an opening 50 formed during the folding and adhering process.

In FIG. 2B, a side elevational view looking between section B-B and A-A on FIG. 1 is shown. The extensions 22 and 24 have been permanently coupled to one another. As a result, box-edges 38 and 40 have been formed. With reference to FIG. 2C, an elevational view looking into section C-C is shown. In FIG. 2C, sections of all the extensions 18, 24, and 42 are shown permanently secured or coupled to their corresponding extensions 20 and 22. This view looks down into openings 52 and 54 formed during the folding and adhering process. Turing to FIG. 2D, an elevational view looking into section D-D is shown. This view depicts the outside surfaces of box-edges 36 and 38. Finally, looking at FIG. 2E, a plan view of the fully formed, post-production folder 10 is shown.

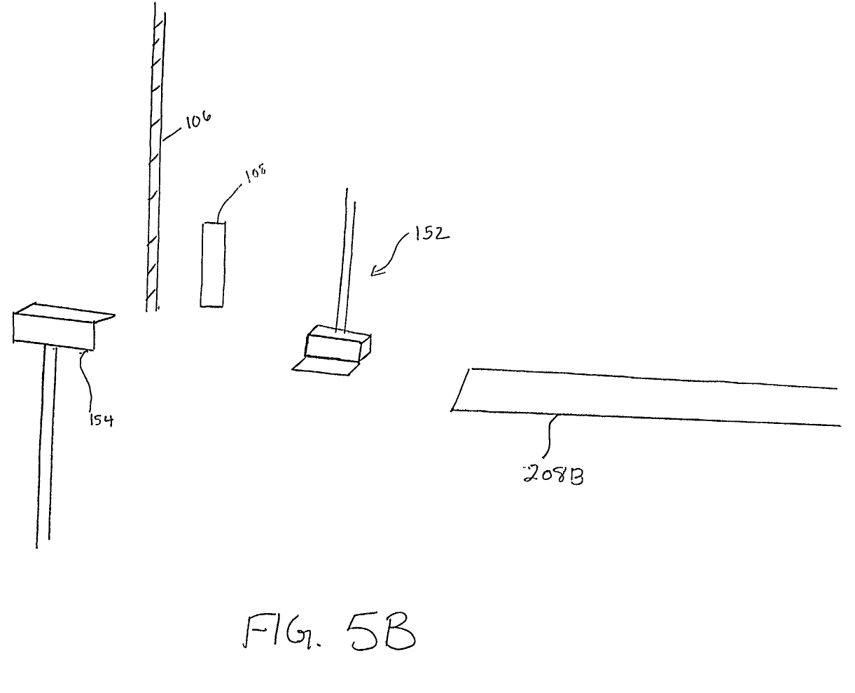

Turning now to FIG. 3, a plan view of a system 90 according to a first embodiment of the present invention is shown. The system 90 comprises a folder-gluer apparatus shown generally at 100 and an apparatus 200, where the apparatus 200 is preferably a box-edge forming apparatus according to one embodiment of the present invention. Preferably, the folder-gluer apparatus 100 is a folder/gluer machine as known in the art and commercially available from a number of manufacturers, such as Universal or Moll. The folder-gluer apparatus 100 typically comprises a belt 102 and supports 104. Also, the folder-gluer apparatus 100 further comprises a folding device 106 and gluing device 108. In a first preferred embodiment the apparatus 200 is coupled to the support 104 in the folder-gluer apparatus 100 via coupling devices 110 (shown in FIG. 4). It is to be appreciated that there may be more or less coupling devices 110 as determined by a particular configuration of apparatus 200 and/or the folder-gluer apparatus 100. If four of the coupling devices 110 are used then an elongated device 205, preferably a bar, becomes optional, although recommended. In a second preferred embodiment, the apparatus 200 is coupled to a section designated by dashed lines 500 that is in turn coupled to the folder-gluer apparatus 100.

A more detailed view of the coupling between folder-gluer apparatus 100 and apparatus 200 is shown in FIG. 4. As can be seen in FIG. 4, the coupling devices 110 are coupled to the supports 104 through use of a coupling rod 112 and a set screw clamp 114, which is continuously adjustable in a linear plane B. As seen in FIG. 4, the supports 104 are located a predetermined position above a belt plane of the machine 200.

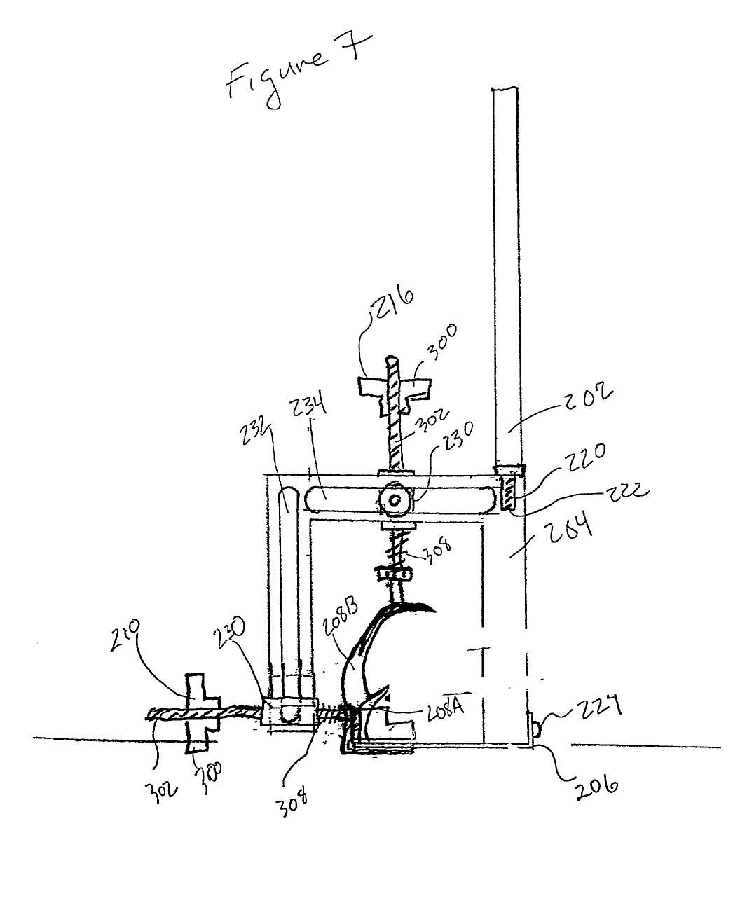

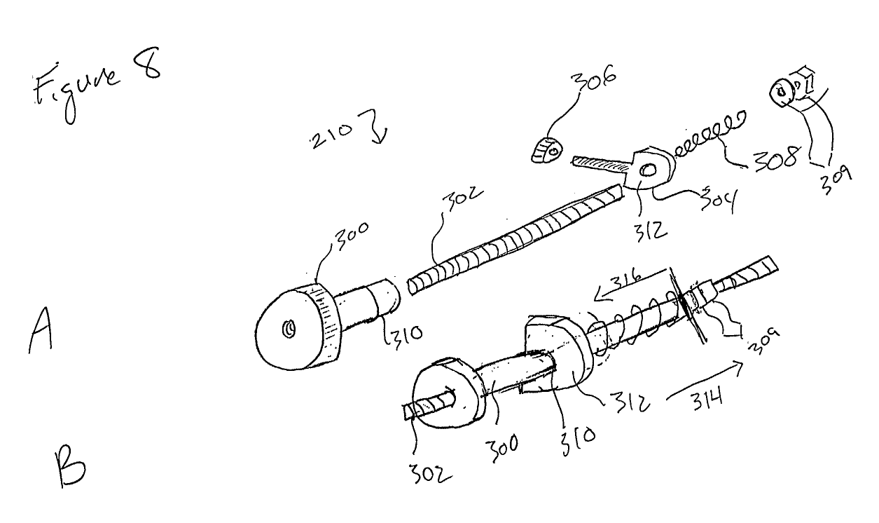

With continuing reference to FIG. 3, the apparatus 200 comprises four extensions 202, preferably rods, coupled to four u-shaped devices 204 supported by the elongated device 205. This preferred arrangement is utilized to couple the apparatus 200 to the folder-gluer apparatus 100 via the coupling devices 110 and 112. The apparatus 200 further comprises a guide system comprising linear guide 206 (best seen in FIG. 7) and a curvilinear guide system 208. The apparatus also comprises an adjustment system comprising adjustment devices 210, 212, 214, and 216, which are shown in more detail in FIGS. 7 and 8A-B below, coupled to the curvilinear guide system 208 on the apparatus 200. Also, system 150 further comprises first and second holding devices 152 and 154, respectively, which are used to hold down a section of the folder 10 before and after a adhesive/gluing and folding operation is performed by the gluing device 108 and the folding device 106 (partially shown).

It is to be appreciated that, although not shown in FIG. 3, if a folder is used similar to folder 10 first and second apparatus 200, gluing devices 108, and folding devices 106 can be utilized. In that alternative preferred embodiment a second apparatus 200, gluing device 108, and folding device 106 can be coupled to the folder-gluer apparatus 100 as is shown by dashed-line rectangles in FIG. 3.

Preferably, the curvilinear guide 208 is made from a Nylon or Teflon coated mild steel that is malleable and has a memory characteristic. Also preferably the linear guide 206 is made from a mild steel that is similar to the curvilinear guide or a high carbon material. Preferably, the u-shaped devices 204 are made from almost any material, such as plastic, zytel, polycarbonate, or metal. Also, preferably, the adjusting devices 210-216 are coupled to the curvilinear guide 208 in a permanent manner, such as being welded, soldered, bonded, or other ways known in the art. Further, it is to be appreciated that if all the extensions 202 were coupled to the folder-gluer apparatus 100, then elongated device 205 could be removed from the system 150 without materially effecting the overall function of the invention. Finally, preferably the gluing device 108 is a hot melt or thermoplastic gluing device in order to achieve nearly immediate set-up between mated extensions.

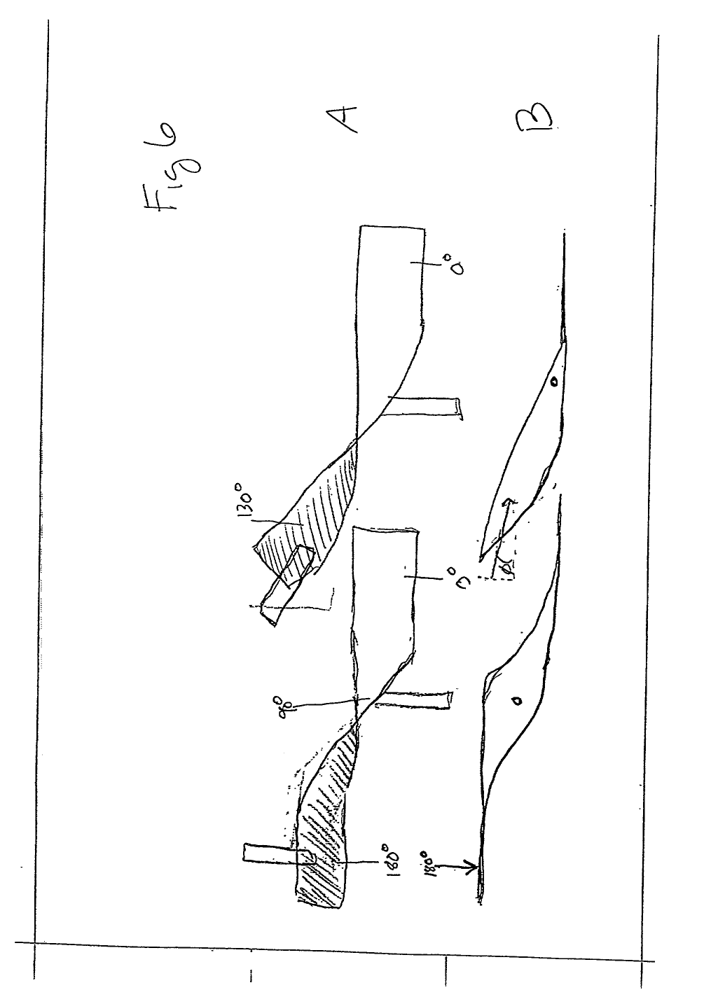

With reference now to FIG. 5A, the apparatus 200 is shown in more detail. As can be clearly seen, the curvilinear guide 208 (shown in FIG. 3) is preferably comprised of first and second curvilinear guides 208A and 208B, respectively, which are also shown in FIGS. 6A-B in more detail. The first curvilinear guide 208A progresses from about a 0° section (all sections are relative to the plane of belt 102) that is used to catch a leading edge of extension 18 or 24. Then the first curvilinear guide 208A twists clockwise to about a 90° section and then continues to twist clockwise to a greater than about 110° section. At the point the first curvilinear guide 208A is going through about 100° its length overlaps the beginning of the second curvilinear guide 208B. This second curvilinear guide 208B begins with about a 90° section and twists clockwise to end at about a 180° section. In applications where the folder-gluer apparatus 100 were equipped with two systems 150 then the twisting of the curvilinear sections in the complementary set of guides would be counter-clockwise.

With continuing reference to FIG. 5A, adjusting devices 210 and 212 are coupled to the first curvilinear guide 208A at the about 90 and 110° sections, respectively. The about 90° section has a first about 0° adjustment device 210 and the about 110° section has about a 30° adjustment device 212. Also, adjusting devices 214 and 216 are coupled to the second curvilinear device at the about 90 and 180° sections, respectively. The about 90° section has a second about 0° adjustment device 214 and the about 180° section has an about 90° adjustment device.

With reference to FIG. 5B, adjacent an end of the curvilinear device 208 is the first holding device 152, the gluing device 108, the folding device 106 (shown in section), and the second holding device 154. The first holding device 152 is used to hold into place an outside surface of the previously folded over extension 24 while the top surface has glue applied to it, and just before the extension 22 is folded upward and over, utilizing the folding device 106, until the underside of extension 22 contacts the adhesive or glue on the outside surface of the extension 24. Immediately after this occurs, the second holding device 154 bears upon an outside surface of the extension 22 so that the extension 22 is between the second holding device 154 and the glue bearing surface of extension 22 and 24. This configuration allows for immediate and proper pressure between extensions 22 until the adhesive or glue layer in between them has set up, and is configured to maintain the extensions in a predetermined orientation, preferably 90°, while the glue sets.

A more detailed view of the couplings between the extension 202, u-shaped device 204, adjusting devices 210 and 216, linear guide 206, and curvilinear guides 208A and 208B is shown in FIG. 7. To couple the extension 202 into the u-shaped support 204, a threaded end 220 of the extension 202 is screwed into a threaded opening 222 in the u-shaped device. To couple the linear guide 206 to the u-shaped device 204, a screw or bolt 224 is inserted through a hole in the linear guide 206 and into or through the u-shaped device 204. To couple the adjusting devices, where 210 and 216 are shown as examples, to the u-shaped device 204, coupling devices 230 are used, which can be any type of retaining device that functions to hold a cylindrical object to a rectilinear object. For the first about 0° adjusting device 210, a slotted opening 232 interacts with the coupling device 230 and for the about 180° adjusting device 216, a slotted opening 234 interacts with the coupling device 230. Finally, the curvilinear devices 208A-B are coupled to the apparatus 200, as was described above, via their permanent attachment to ends of the adjusting devices 210, 212, 214 & 216.

The detailed view of the adjusting device 210 according to a first embodiment of the present invention is shown in FIGS. 8A-B. Since all the adjusting devices are functionally the same, only one is being described for convenience. These adjusting devices 210, 212, 214 & 216 are comprised of knurled and internally threaded knobs 300, all-thread rods 302, extension bolts 304 with accompanying nuts 306, springs 308, and nut/washer system 309. When assembled, as seen in FIG. 8B, an end 310 of the knob 300 contacts a first surface 312 of the extension bolt 304 while the knob 300 is threaded on to the all-thread rod 302. Then, by turning the knob 300 clockwise, spring 308 is compressed between the first surface 312 and the bolt/washer system 309. Compressed spring 308 then exerts a force through its interaction with the all-thread rod 302, the first surface 312, and the bolt/washer system 309 in the direction of arrow 314, which, in turn, causes force on the curvilinear guide 208 making it deflect in the desired direction. Conversely as the knob 300 is turned in a counter-clockwise direction, tension in the spring 308 is decreased, relieving a portion of the force previously applied to curvilinear guide 208. Thus, through this adjustment of the tension in the spring 308, the guide 208 can be either corsely or finely adjusted to a position that most accurately fold extensions 16, 18, 20, 22, and 24 of folder 10, usually to form 90° pockets. As was noted above, this preferred configuration allows fine-tuning during the running, i.e., “on the fly,” of the folder-gluer-apparatus 100, thus saving valuable production time.

An operation of the system 150 will now be described with reference mostly to FIGS. 1 and 5A-5B for a single box-edge fold to form a box-edge between the extensions 22 and 24. It should be noted that during production of folders as hereinafter described, the flow of folder materials through the folder/gluer machine is constant with all actions being performed without stopping or slowing the equipment. As can be seen in FIG. 1, the folder 10 travels in the direction of the arrow through the folder-gluer apparatus 100 via belt 102 (FIG. 3). The edge of the extension 24 is fed between the curvilinear guide 208A and the linear guide 206. As the edge advances along the curvilinear guide 208A it begins to bend at score line 400, forcing the extension 24 from about a 0°, through about 90° at the 90° section of the curvilinear guide 208A, to just past 100° at the end of the curvilinear guide 208A.

After passing through 100° on the curvilinear guide 208A, the edge of the extension 24 contacts curvilinear guide 208B, which causes a bend at score line 402. By bending at score line 402, the extension 24 begins to move towards the right side main body 28. The extension 24 passes by the 90° section of the curvilinear guide 208B, and then breaks along score line 400 and moves toward becoming parallel with the right side main body 28 as the extension 24 travels along in bearing contact with the curvilinear guide. At about the 180° section of curvilinear guide 208B, the face of extension 24 is roughly parallel to the surface of main body 28. During set up and periodically during production, an operator will monitor the bending of the extension 24, and fine tune the breaking at score lines 400 and 402 using the adjusting devices 210, 212, 214, 216. The goal being to create clean 90° breaks at score lines 400 and 402.

With reference to FIG. 5B, while the extension 24 passes from the end of curvilinear guide 208B it is maintained in a parallel orientation to the right-side main body 28 through use of the holding device 152 bearing upon the user surface of the extension. Holding device 152 holds down the extension 24 which receives an application of adhesive as it passes under the gluing device 108. Immediately after glue has been applied to extension 24, the leading edge of extension 22 is forced upwardly by a pusher plate assembly in the folder/gluer table (as known in the art). The upward turned leading edge of extension 22 is then engaged by the confronting edge of folding device 106. Folding device 106 forces bend back toward main body at 404 and then 406 until the inside surface of the extension 22 comes into mating contact with the outside and glue bearing surface of extension 24. At this point the extension 22 is parallel with right side main body 28 and has formed a 90° pocket in connection with folded extension 24. As the now folded and glued extensions 22 and 24 travel along the holding device 154 maintains the two extensions bed of the folder/gluer 100, in the proper, 90°, orientation as the glue between them quickly sets.

As can be appreciated, the same operation can be occurring simultaneously on both sides of the folder-gluer apparatus 100 if the two apparatus 200, gluing devices 108, and folding devices 106 are coupled to the folder-gluer apparatus 100.

From the above description of the invention, those skilled in the art will perceive improvements, changes and modifications in the invention. Such improvements, changes and modifications within the skill of the art are intended to be covered.

I claim:

1. An apparatus comprising:
a coupling system;
a guiding system operatively configured to interact with an object to form a box-edge on a portion of the object; and
an adjusting system operatively configured to adjust predetermined portions of the guiding system such that the box-edge conforms to predetermined parameters.

2. The apparatus of claim 1, wherein the coupling system comprises:
an elongated device;
u-shaped devices, each of the u-shaped devices comprising extensions operatively configured to interact with the elongated device; and
coupling devices operatively configured to interact with the extensions.

3. The apparatus of claim 1, wherein the guiding system comprises curvilinear guides.

4. The apparatus of claim 3, wherein the curvilinear guides comprise:
a first curvilinear guide operatively configured to curve from about 0° to about 130° from a proximal end that initially contacts the object to a distal end; and
a second curvilinear guide operatively coupled to curve from about 0° to about 180° from a second proximal end proximate the distal end of the first curvilinear guide to a second distal end.

5. The apparatus of claim 1, wherein the adjusting system comprises:
fine adjusting devices comprising:
a first end coupled to a handle device; and
a second end that is coupled to the guiding system.

6. A system comprising:
a folder-gluer apparatus; and
an apparatus comprising:
a coupling system;
a guiding system operatively configured to interact with an object to form a box-edge on a portion of the object; and
an adjusting system operatively configured to adjust predetermined portions of the guiding system such that the box-edge conforms to predetermined parameters.

7. The system of claim 6, wherein the folder-gluer apparatus further comprises:
first and second holding devices;
a gluing device; and
a folding device;
wherein the apparatus is operatively positioned adjacent the first holding device.

8. The system of claim 6, wherein the coupling system comprises:
an elongated device;
u-shaped devices, each of the u-shaped devices comprising extensions operatively configured to interact with the elongated device; and
coupling devices operatively configured to interact with the extensions.

9. The system of claim 6, wherein the guiding system comprises curvilinear guides.

10. The system of claim 9, wherein the curvilinear guides comprise:
a first curvilinear guide operatively configured to curve from about 0° to about 130° from a proximal end that initially contacts the object to a distal end; and
a second curvilinear guide operatively coupled to curve from about 0° to about 180° from a second proximal end proximate the distal end of the first curvilinear guide to a second distal end.

11. The system of claim 6, wherein the adjusting system comprises:
fine adjusting devices comprising:
a first end coupled to a handle device; and
a second end that is coupled to the guiding system.

12. The system of claim 6, wherein the apparatus is coupled to a section that is operatively configured to be inserted into the system.

13. The system of claim 6, wherein the system further comprises:
another apparatus, wherein the another apparatus is operatively positioned on an opposite side of the system than the apparatus.

14. A method comprising the steps of:
a) feeding an object into a first portion of a system;
b) moving the object from the first portion of the system to a second portion of the system;
c) interacting a portion of the object with an apparatus in the second portion of the system to form a box-edge section on the object;
d) interacting sections of the object with a third portion of the system to secure the box-edge section; and
e) moving the object to a fourth portion of the system after the box-edge section is secured.

15. The method of claim 14, the c) interacting step further comprising the step of fine adjusting sections of the second portion of the system such that the box-edge section conforms to predetermined parameters.

16. The method of claim 14, the interacting further comprising the steps of:
interacting the sections of the object with a first section of the second portion of the system to move the sections of the object from a 0° plane to a 130° plane; and
interacting the sections of the object with a second section of the second portion of the system to move the sections of the object from the 130° plane to a 180° plane;
wherein the box-edge section is completely formed at the 180° plane.

17. The method of claim 14, wherein while the object is continuously moving the securing further comprising the steps of:
holding the box-edge section with a first holding device;
depositing adhesive material onto an adhesive receiving section of the box-edge section;
folding over a folding section of the object with a folding device onto the adhesive material; and
holding the folding section on the adhesive material deposited on the adhesive section of the box-edge section with a second holding device.

18. The method of claim 14, further comprising the step of compiling the object with the box-edge section with other objects with a box-edge section in the fourth portion of the system.
